(19) United States
(12) Patent Application Publication
(10) Pub. No.: US 2017/0364233 A1
(43) Pub. Date: Dec. 21, 2017

(54) OPERATION PROCESSING METHOD, ELECTRONIC DEVICE, AND COMPUTER STORAGE MEDIUM

(71) Applicant: Tencent Technology (Shenzhen) Company Limited, Shenzhen (CN)

(72) Inventor: Baihan CAI, Shenzhen (CN)

(21) Appl. No.: 15/694,612

(22) Filed: Sep. 1, 2017

Related U.S. Application Data
(63) Continuation-in-part of application No. PCT/CN2016/081342, filed on May 6, 2016.

(30) Foreign Application Priority Data
Jul. 6, 2015 (CN) 201510392480.5

(51) Int. Cl. G06F 3/0488; G06F 3/0485

(52) U.S. Cl. CPC G06F 3/0488; G06F 3/04855

(57) ABSTRACT

A method for performing an operation in accordance with a user interaction with a touch-sensitive display of an electronic device includes the following steps: detecting a finger-touch operation received by a progress bar on the touch-sensitive display; extracting a set of feature parameters from the finger-touch operation; parsing the set of feature parameters to identify candidate operating points; selecting a target operating point from the candidate operating points when the finger-touch operation is deemed to be in a release phase; and updating the progress bar and content associated with the progress bar to a predefined position that corresponds to the target operating point. The present disclosure may be implemented to eliminate, when an error exists in a touch operation of a user on a display unit, impact of the operation error to an operation result displayed on an image interface, so as to ensure correctness of the operation result.

### RELATED APPLICATIONS

This application is a continuation-in-part of PCT/CN2016/081342, entitled “OPERATION PROCESSING METHOD, AND ELECTRONIC DEVICE AND COMPUTER STORAGE MEDIUM” filed on May 6, 2016, which claims priority to Chinese Patent Application No. 201510392480.5, filed with the State Intellectual Property Office of the People's Republic of China on Jul. 6, 2015, and entitled “OPERATION PROCESSING METHOD, AND ELECTRONIC DEVICE AND COMPUTER STORAGE MEDIUM”, both of which are incorporated herein by reference in their entirety.

### FIELD OF THE TECHNOLOGY

The present disclosure relates to the operating technologies of electronic devices, and in particular, to an operation processing method, an electronic device, and a computer storage medium.

### BACKGROUND OF THE DISCLOSURE

When a user performs a touch operation on an electronic device such as a smartphone or a tablet computer, an operation with an error is often implemented on a graphical interface of an electronic device of the user due to reasons such as hardware quality, an external environment, or sensitivity of the operation implemented by the user. As a result, an operation result of the electronic device that is displayed on the graphical interface is significantly different from an operation result expected by the user. For example, the user expects to drag a web page through a drag operation when browsing the web page, so as to quickly preview web content. The user releases the drag operation when the user finds web content that is expected to read. In this case, if jitter occurs in the operation due to reasons of the user or impact of an external environment (for example, being in a jerky vehicle), web content finally displayed by the electronic device is different from content that is found by the user during the quick preview and that is expected to read. The user needs to implement a drag operation again to locate the content that needs to be read. Frequent operations reduce an operating efficiency of the user, and affect user experience.

In view of the above, the related technology has no effective solutions for problems that an operation error of the user affects correctness of an operation result responded by an electronic device.

### SUMMARY

Embodiments of the present disclosure provide an operation processing method, an electronic device, and a computer storage medium, so as to eliminate impact of the operation error on a responded operation result when an error exists in an operation, thereby ensuring correctness of the operation result.

Technical solutions of the embodiments of the present disclosure are implemented as follows:

According to a first aspect, an embodiment of the present disclosure provides an operation processing method, including:
detecting a finger-touch operation received by a progress bar, extracting a set of feature parameters from the finger-touch operation;
parsing the set of feature parameters to identify candidate operating points, and
selecting a target operating point from the candidate operating points when the finger-touch operation is deemed to be in a release phase; and

updating the progress bar and content associated with the progress bar to a predefined position that corresponds to the target operating point.

According to a second aspect, an embodiment of the present disclosure provides an electronic device, including:
a detection unit, configured to detect a finger-touch operation received by a progress bar, extracting a set of feature parameters from the finger-touch operation;
a parsing unit, configured to parse the feature parameter, and select a target operating point from the candidate operating points when the finger-touch operation is deemed to be in a release phase; and

a display unit, configured to display target content that is in content loaded on the graphical interface and that corresponds to the target operating point.

According to a third aspect, an embodiment of the present disclosure provides a computer storage medium, the computer storage medium storing an executable instruction, and the executable instruction being used for implementing the operation processing method provided in the embodiments of the present disclosure.

### BRIEF DESCRIPTION OF THE DRAWINGS

FIG. 1-1 to FIG. 1-3 are schematic diagrams of a preview operation according to the related technology;

FIG. 2-1 and FIG. 2-2 are second schematic diagrams of a preview operation according to the related technology;

FIG. 3-1 and FIG. 3-2 are schematic diagrams of adjusting a preview accuracy according to the related technology;

FIG. 4 is a first flowchart of implementing an operation processing method according to an embodiment of the present disclosure;

FIG. 5 is a schematic diagram that an operation is at difference phases according to an embodiment of the present disclosure;

FIG. 6 is a first schematic diagram of a feature parameter of an operation according to an embodiment of the present disclosure;

FIG. 7 is a first schematic diagram of an operation of an electronic device according to an embodiment of the present disclosure;

FIG. 8 is a second flowchart of implementing an operation processing method according to an embodiment of the present disclosure;

FIG. 9 is a second schematic diagram of a feature parameter of an operation according to an embodiment of the present disclosure;

FIG. 10 is a second schematic diagram of an operation of an electronic device according to an embodiment of the present disclosure;

FIG. 11 is a third flowchart of implementing an operation processing method according to an embodiment of the present disclosure;

FIG. 12 is a third schematic diagram of a feature parameter of an operation according to an embodiment of the present disclosure;

FIG. 13 is a third schematic diagram of an operation of an electronic device according to an embodiment of the present disclosure;

FIG. 14 is a fourth flowchart of implementing an operation processing method according to an embodiment of the present disclosure;

FIG. 15 is a fourth schematic diagram of a feature parameter of an operation according to an embodiment of the present disclosure;

FIG. 16 is a fifth schematic diagram of a feature parameter of an operation according to an embodiment of the present disclosure;

FIG. 17 is a fifth flowchart of implementing an operation processing method according to an embodiment of the present disclosure;

FIG. 18 is a sixth schematic diagram of a feature parameter of an operation according to an embodiment of the present disclosure;

FIG. 19 is a seventh schematic diagram of a feature parameter of an operation according to an embodiment of the present disclosure; and

FIG. 20 is a schematic diagram of a functional structure of an electronic device according to an embodiment of the present disclosure.

### DESCRIPTION OF EMBODIMENTS

The present disclosure is further described below in detail with reference to the accompanying drawings and the embodiments. It should be understood that the specific embodiments described herein are merely intended to explain the present disclosure, but are not intended to limit the present disclosure.

In the related technology, when a user performs a finger-touch operation on the touch-sensitive display (e.g., touchscreen) of an electronic device such as a smartphone or a tablet computer, an operation with an error is often implemented on a graphical interface of an electronic device of the user due to reasons such as hardware quality, an external environment, or sensitivity of the operation implemented by the user. As a result, an operation result of the electronic device that is displayed on the graphical interface is significantly different from an operation result expected by the user.

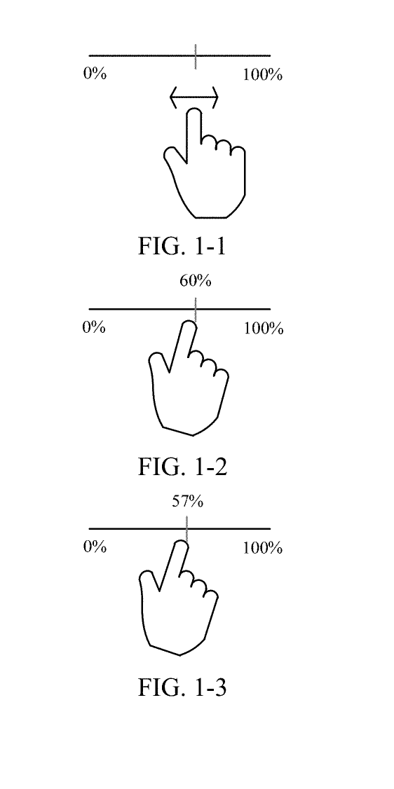

For example, when the graphical interface rendered on the touchscreen of the electronic device is loaded with content (for example, a web page), usually a display unit cannot display all the loaded content at one time. Correspondingly, a preview status bar shown in FIG. 1 may be displayed, and the user is allowed to implement a drag operation on the preview status bar (may be considered as a progress bar), so as to preview different parts of the loaded content (different parts of the content are represented in a hundred-mark system in FIG. 1). When 60% of the content is previewed and content of this part is expected to be read, content of a 60% progress part is displayed on the graphical interface of the electronic device by releasing the drag operation. In this case, if a release operation of the user has an error (for example, a hand jitters when the user releases), content of a 57% progress part is displayed by the electronic device when the user releases the drag operation. In this way, the user further needs to drag the preview status bar again to adjust the electronic device to display content of the progress that needs to be viewed. Repeated operations reduce an operating efficiency, and also affect user experience.

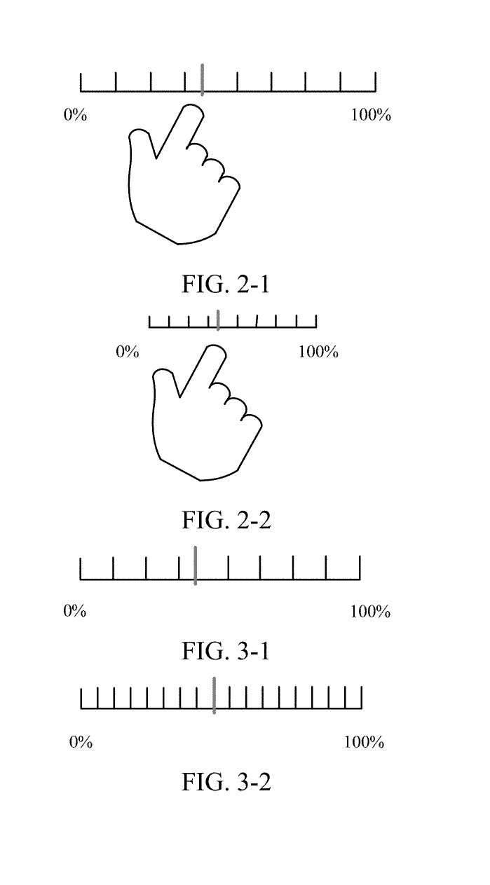

The preview status bar shown in FIG. 1-1 has a progress indicator, so that the user can drag the progress indicator to control progress of a file (for example, a multimedia file, or a text file). A size of an operational area that is allocated for the preview status bar on the graphical interface of the electronic device is a common case in an embodiment of the present disclosure (that is, the operational area allocated for the preview status bar is sufficient for the user to perform an accurate progress adjustment). However, an error still is inevitable when the user drags the progress indicator to adjust the progress. For example, when the progress indicator of the preview status bar that is dragged by the user is expected to stay at a position of progress of 60% shown in FIG. 1-2, if a finger of the user jitters when the user releases the progress indicator, slight displacement is caused to a preview indicator. As a result, the preview indicator stays at a position of progress of 57% shown in FIG. 1-3.

A size of an operational area that is allocated for a preview status bar on a graphical interface shown in FIG. 2-1 is a common case in an embodiment of the present disclosure. Compared with FIG. 2-1, a size of an operational area that is allocated for a preview status bar on a graphical interface shown in FIG. 2-2 is relatively small. Therefore, a problem of low accuracy of an operation result caused by an operation error becomes more obvious. Usually, an electronic device supports the user to adjust adjustment precision of the preview status bar. The user may adjust the precision of the preview status bar as shown in FIG. 3-1 and FIG. 3-2, for example, adjust from 100% to 40%. However, in actual applications, an error in the user operation is inevitable, and it is difficult to ensure, in a manner of adjusting the precision only, accuracy of the operation result that is responded at the display unit by the electronic device with regarding to the touch operation of the user.

In view of the foregoing problems, in the embodiments of the present disclosure, an electronic device obtains, by detecting a finger-touch operation received by a progress bar of a display unit, a set of feature parameters of the finger-touch operation; and determines, by parsing the set of feature parameters to identify candidate operating points, a true intention of a touch operation of a user at the display unit. Based on the true intention of the user operation, a target operating point is selected from the candidate operating points when the finger-touch operation is deemed to be in a release phase. The selected target operating point is an operating point obtained after an error of the user operation is eliminated. A target content that is in content loaded on the graphical interface and that corresponds to the target operating point is displayed. For example, when the operation implemented by the user is used for adjusting the progress, the target content is content of progress that is in content correspondingly displayed on the graphical interface and that corresponds to the target operating point.

Subsequent specific embodiments of the present disclosure describe that the user implements the following operation: the graphical interface of the display unit does not display all the loaded content (for example, content of 10 pages is loaded when the display unit is buffering, but the graphical interface only currently displays content of a first page). The operation implemented at the display unit by the user is dragging a progress indicator in a preview status bar that is loaded on the graphical interface of the display unit. Therefore, progress of the content loaded by the display unit is adjusted, so that the electronic device is enabled to load, on the graphical interface, content of the corresponding progress (that is, the target content). Certainly, this does not limit the present disclosure. According to the technical solutions provided by the embodiment of the present disclosure, the present disclosure can also be applied to any other scenarios in which a corresponding operating point while the user releasing the touch operation needs to be determined when the user implements, at the display unit, a touch operation having displacement.

This embodiment discloses an operation processing method. The technical solution disclosed in this embodiment may be applied to any electronic device that supports touch control, such as a smartphone or a tablet computer. Usually, a graphical interface based application can run in the electronic device. An operation of a user is received by a display unit that supports a touch operation, and an operation result is responded based on the user operation. The operation disclosed in the following embodiments may be an operation implemented by any graphical interface of the electronic device, including a launcher interface of the electronic device, a system setting interface of the electronic device, a multimedia playback interface of the electronic device, an operation interface of a preinstalled application (for example, a system setting tool) of the electronic device, and an operation interface of any third-party application (for example, a social networking application) installed in the electronic device.

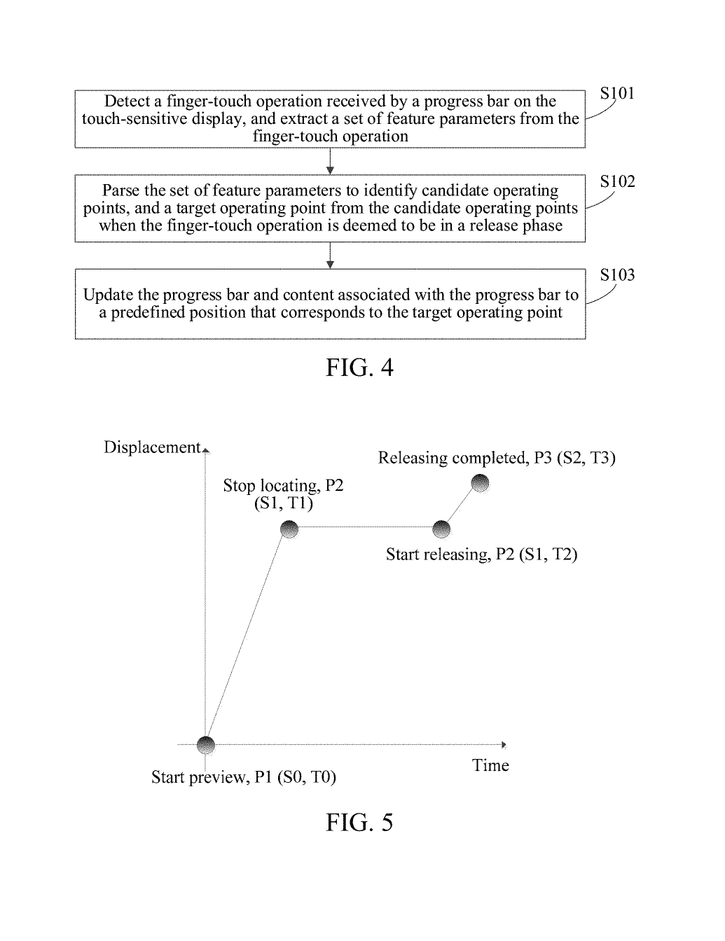

As shown in FIG. 4, the operation processing method disclosed in this embodiment includes the following steps:

Operation S101: Detect a finger-touch operation received by a progress bar, and extract a set of feature parameters from the finger-touch operation.

Herein, it is supposed that the finger-touch operation is dragging a progress indicator in a preview status bar that is loaded on the graphical interface, so as to adjust progress. Therefore, the electronic device is enabled to load, on the graphical interface, content of the corresponding progress (that is, the target content).

When the operation is received on graphical interface, a series of operating points that constitute an operation (an operating point is a minimum identification unit for identifying the operation implemented by the user in the display unit of the electronic device) are detected, so as to detect a set of time parameters and a set of positional parameters of a sensed operating point, that is, a moment when the operating point is sensed and a corresponding position (representing a position of the operating point in the display unit).

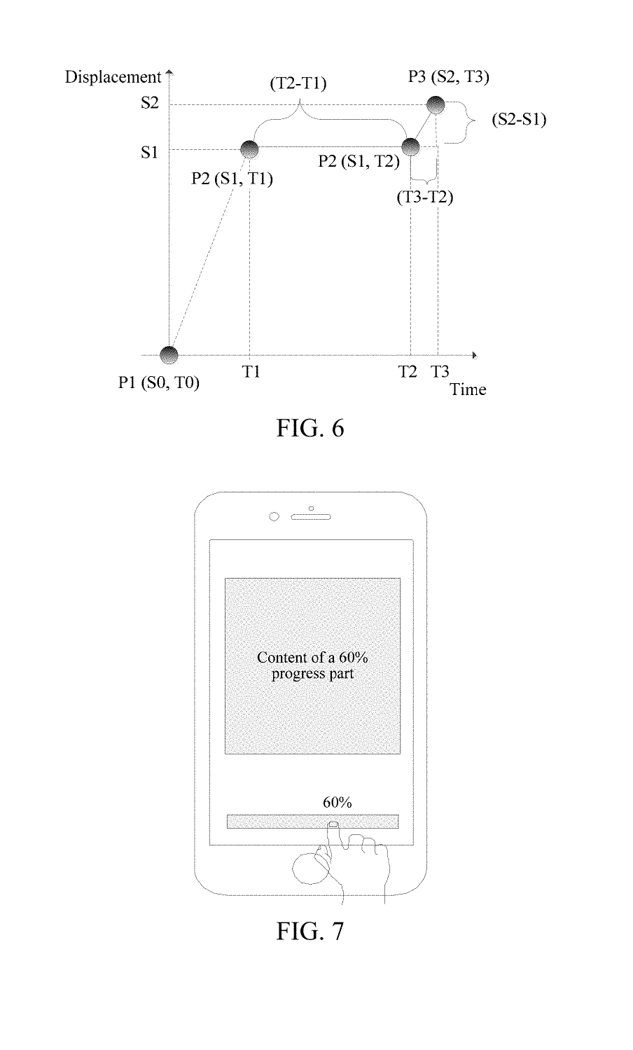

Based on the set of time parameters and the set of positional parameters of the operating point, at least one of the following set of feature parameters shown in FIG. 5 and FIG. 6 is determined.

1) Preview duration T2−T1, where the preview duration is a duration for which the finger-touch operation is deemed to be in a preview phase.

2) A feature parameter P2 (S1, T2) of a first operating point, where the first operating point is an operating point on the graphical interface when the operation enters a release phase, and the feature parameter of the first operating point includes a set of time parameters (representing a last moment when the first operating point is detected) T2 and a set of positional parameters S1 (a position of the first operating point in the display unit) of the first operating point.

3) A feature parameter P3 (S2, T3) of a second operating point, where the second operating point is an operating point on the progress bar when the finger-touch operation completes the release phase, and the feature parameter of the second operating point includes a set of time parameters (representing a last moment when the second operating point is detected) T3 and a set of positional parameters S2 (a position of the second operating point in the display unit) of the second operating point.

4) Release displacement S2−S1, where the release displacement is corresponding displacement on the progress bar when the finger-touch operation is deemed to be in the release phase. That is, during a period in which a finger of the user releases contact with the display unit (in this case, it is detected that an area of the operating point starts to decrease) until the finger completely does not contact the display unit (in this case, the operating point is not detected), displacement implemented in the display unit by the finger of the user usually is caused by jitter of the finger when the operation is released.

5) Release duration T3−T2, where the release duration is a duration for which the finger-touch operation is deemed to be in the release phase.

As shown in FIG. 5 and FIG. 6, when the user starts to implement a drag operation to preview content of different progress parts of the content loaded on the graphical interface (for example, a multimedia file, a web page, or a document), a starting operating point P1 (S0, T0) corresponding to the operation is started to be previewed. S0 represents a position of P1 on the graphical interface, and T0 indicates a moment when P1 is detected. It is detected that a corresponding operating point when the user stops the drag operation is P2 (S1, T1). The electronic device identifies the operating point P2 (S1, T1), the set of positional parameters, and the corresponding set of time parameters T1. Moreover, the set of positional parameters S1 represents, by using S0 as displacement fiducial, displacement of the operating point P2 with respect to the operating point P1.

When it is sensed that an area of an operating point corresponding to the operating point P2 (S1, T2) starts to decrease at the moment T2, it represents that a contact area of a touch point of the finger of the user and the display unit starts to decrease, and the user starts to release the operation at the operating point P2 (S1, T2). Therefore, a difference of the T2−T1 is preview duration corresponding to the preview phase (from the moment T1 to the moment T2 in FIG. 6).

If jitter occurs during a process that the user releases the operation (that is, from the moment T2 to the moment T3 in FIG. 6), a position at which the finger of the user touches the display unit changes. As a result, the operating point P3 (S2, T3) is finally identified. The operating point P3 (S2, T3) corresponds to the second operating point, and a set of positional parameters (a position in the display unit) thereof is different from that of the operating point P2 (the first operating point). A difference T3−T2 between the set of time parameters T2 of the operating point P2 and the set of time parameters T3 of the operating point P3 is the duration in which the operation is in the release phase. Displacement S2−S1 of the operating point P3 (an operating point at which releasing of the operation is completed) with respect to the operating point P2 is displacement generated when the operation is in the release phase (that is, the release displacement).

Operation S102: Parse the feature parameter, and select a target operating point from the candidate operating points when the finger-touch operation is deemed to be in a release phase.

The target operating point may be any operating point between the operating point P2 and the operating point P3, including the operating point P2 and the operating point P3.

Operation S103: Update the progress bar and content associated with the progress bar to a predefined position that corresponds to the target operating point.

The target operating point serves as an operating point at which the operation of the user is released, and therefore progress indicated by the operation of the user may be determined based on displacement of the target operating point with respect to the corresponding operating point P1 when locating is started. For example, when progress indicated in FIG. 7 is 60%, content of a 60% progress part in a content source of the graphical interface serves as the target content and is displaced on the graphical interface.

This embodiment discloses an operation processing method. The technical solution disclosed in this embodiment may be applied to any electronic device having a display unit that supports a touch operation, such as a smartphone or a tablet computer. Usually, a graphical interface based application can run in the electronic device. An operation of a user is received by using the display unit that supports the touch operation, and an operation result is responded based on the user operation. The operation disclosed in the following embodiments may be an operation implemented by any graphical interface of the electronic device, including a launcher interface of the electronic device, a system setting interface of the electronic device, a multimedia playback interface of the electronic device, an operation interface of a preinstalled application (for example, a system setting tool) of the electronic device, and an operation interface of any third-party application (for example, various social networking applications and navigation applications) installed in the electronic device.

As shown in FIG. 8, the operation processing method disclosed in this embodiment includes the following steps:

Operation S201: Detect a finger-touch operation received by a progress bar, and extract a set of feature parameters from the finger-touch operation.

Herein, it is supposed that the finger-touch operation is dragging a progress indicator in a preview status bar that is loaded on the graphical interface, so as to adjust progress. Therefore, the electronic device is enabled to display, on the graphical interface, content of the corresponding progress (that is, the target content).

When the operation is received on graphical interface, a series of operating points that constitute an operation (an operating point is a minimum identification unit for identifying the operation implemented by the user in the display unit of the electronic device) are detected, so as to detect a set of time parameters and a set of positional parameters of a sensed operating point, that is, a moment when the operating point is sensed and a corresponding position (representing a position of the operating point in the display unit).

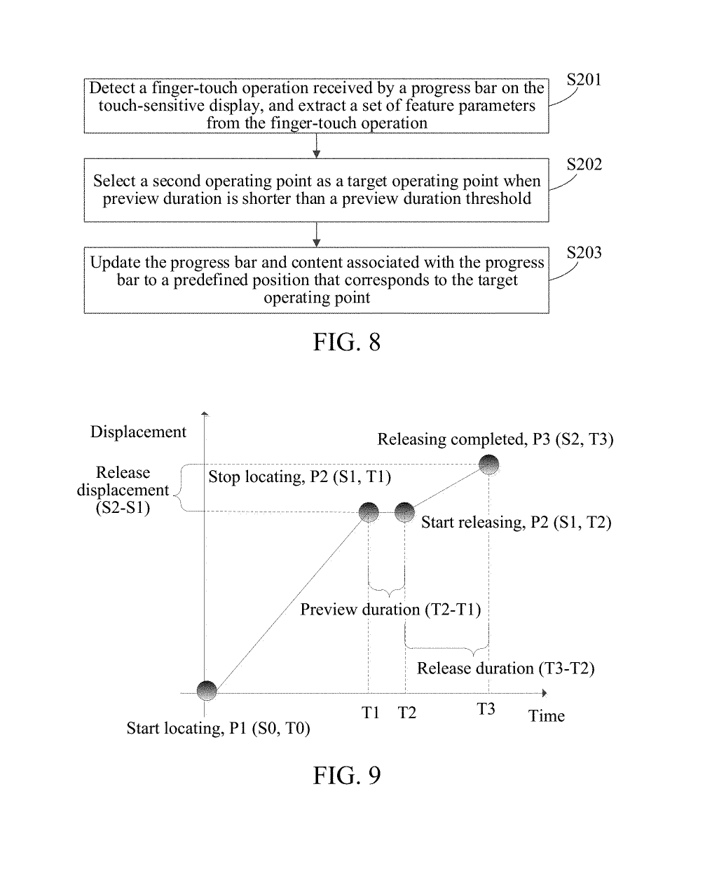

Based on the set of time parameters and the set of positional parameters of the operating point, at least one of the following set of feature parameters shown in FIG. 9 is determined.

1) Preview duration T2−T1, where the preview duration is a duration for which the finger-touch operation is deemed to be in a preview phase.

2) A feature parameter P2 (S1, T2) of a first operating point, where the first operating point is an operating point on the graphical interface when the operation enters a release phase, and the feature parameter of the first operating point includes a set of time parameters (representing a last moment when the first operating point is detected) T2 and a set of positional parameters S1 (a position of the first operating point in the display unit) of the first operating point.

3) A feature parameter P3 (S2, T3) of a second operating point, where the second operating point is an operating point on the progress bar when the finger-touch operation completes the release phase, and the feature parameter of the second operating point includes a set of time parameters (representing a last moment when the second operating point is detected) T3 and a set of positional parameters S2 (a position of the second operating point in the display unit) of the second operating point.

4) Release displacement S2−S1, where the release displacement is corresponding displacement on the progress bar when the finger-touch operation is deemed to be in the release phase. That is, during a period in which a finger of the user releases contact with the display unit (in this case, it is detected that an area of the operating point starts to decrease) until the finger completely does not contact the display unit (in this case, the operating point is not detected), displacement implemented in the display unit by the finger of the user usually is caused by jitter of the finger when the operation is released.

5) Release duration T3−T2, where the release duration is a duration for which the finger-touch operation is deemed to be in the release phase.

As shown in FIG. 9, when the user implements a drag operation at the operating point P1 on the graphical interface to locate content of different progress parts of content loaded on the graphical interface (for example, a multimedia file, a web page, or a document), the electronic device identifies, when the user stops the drag operation at the operating point P2, the set of time parameters T1 and the set of positional parameters S1 that correspond to the operating point P2. S1 is a position of P2 when P1 (S0, T0) serves as displacement fiducial. The set of positional parameters of P2 represents displacement of the operating point P2 with respect to the operating point P1.

When it is sensed that an area of an operating point corresponding to the operating point P2 starts to decrease at the moment T2, it represents that a contact area of a touch point of the finger of the user and the display unit starts to decrease, and represents that the user finishes the preview and starts to release the operation at the operating point P2. Therefore, a difference T2−T1 between T2 and T1 is the preview duration.

If jitter occurs during a process that the user releases the operation, a position at which the finger of the user touches the display unit changes. As a result, the set of positional parameters of the operating point P3 (S2, T3) (the second operating point) that is finally identified is different from the set of positional parameters (a position in the display unit) of the operating point P2 (the first operating point). A difference between the set of time parameters T2 of the operating point P2 and the set of time parameters T3 of the operating point P3 is the duration in which the operation is in the release phase. Displacement S2−S1 of the operating point P3 with respect to the operating point P2 is displacement generated when the operation is in the release phase (that is, the release displacement).

Operation S202: Select a second operating point as a target operating point when preview duration is shorter than a preview duration threshold.

When the preview duration is shorter than the preview duration threshold, it indicates that the user pays attention to the preview for a very short time, and usually the user does not expect to continue to pay attention to previewed content in the later. If a subsequent release operation of the user has an error, the operating point P3 (the second operating point) that is detected when releasing of the operation of the user is completed is selected as the target operating point.

Operation S203: Update the progress bar and content associated with the progress bar to a predefined position that corresponds to the target operating point.

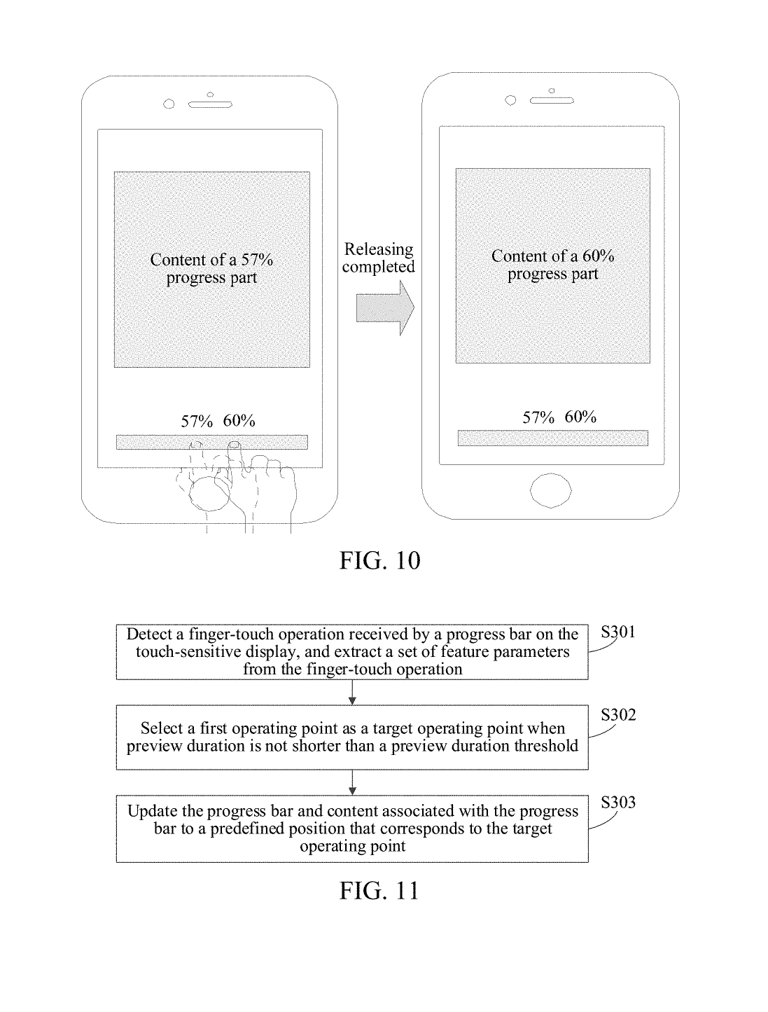

The target operating point serves as an operating point at which the operation of the user is released, and therefore progress indicated by the operation of the user may be determined based on displacement of the target operating point with respect to the corresponding operating point P1 when locating is started. As shown in FIG. 10, when preview duration for the user to preview content of a 57% progress part is shorter than the preview duration threshold, if an operation error occurs when the user releases the operation and the preview duration is shorter than the preview duration threshold, it indicates that the user does not expect to continue to view the content of the 57% progress part. As a result, the electronic device detects that the last operating point (the second operating point) triggers to display content of a 60% progress part, and the content of the 60% progress part in a content source of the graphical interface serves as the target content and is displaced on the graphical interface.

This embodiment discloses an operation processing method. The technical solution disclosed in this embodiment may be applied to any electronic device having a display unit, such as a smartphone or a tablet computer. Usually, a graphical interface based application can run in the electronic device. An operation of a user is received by using the display unit, and an operation result is responded based on the user operation. The operation disclosed in the following embodiments may be an operation implemented by any graphical interface of the electronic device, including a launcher interface of the electronic device, a system setting interface of the electronic device, a multimedia playback interface of the electronic device, an operation interface of a preinstalled application (for example, a system setting tool) of the electronic device, and an operation interface of any third-party application (for example, a social networking application) installed in the electronic device.

As shown in FIG. 11, the operation processing method disclosed in this embodiment includes the following steps:

Operation S301: Detect a finger-touch operation received by a progress bar, and extract a set of feature parameters from the finger-touch operation.

Herein, it is supposed that the finger-touch operation is dragging a progress indicator in a preview status bar that is loaded on the graphical interface, so as to adjust progress. Therefore, the electronic device is enabled to load, on the graphical interface, content of the corresponding progress (that is, the target content).

When the operation is received on graphical interface, a series of operating points that constitute an operation (an operating point is a minimum identification unit for identifying the operation implemented by the user in the display unit of the electronic device) are detected, so as to detect a set of time parameters and a set of positional parameters of a sensed operating point, that is, a moment when the operating point is sensed and a corresponding position (representing a position of the operating point in the display unit).

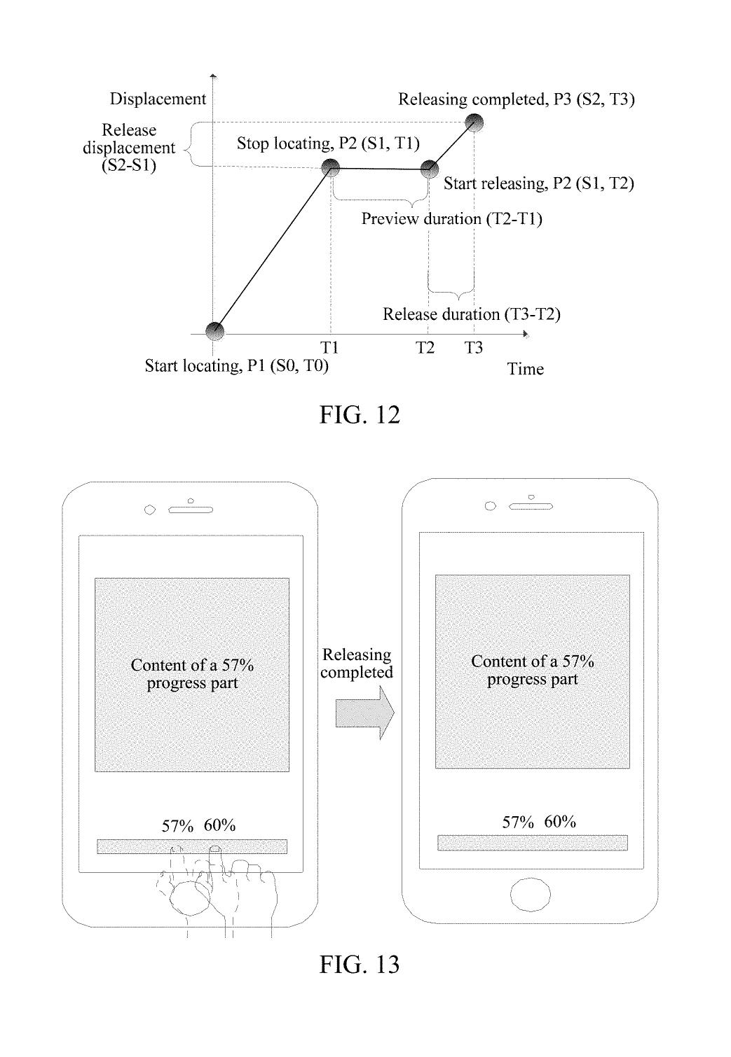

Based on the set of time parameters and the set of positional parameters of the operating point, at least one of the following set of feature parameters shown in FIG. 12 is determined.

1) Preview duration T2−T1, where the preview duration is a duration for which the finger-touch operation is deemed to be in a preview phase.

2) A feature parameter P2 (S1, T2) of a first operating point, where the first operating point is an operating point on the graphical interface when the operation enters a release phase, and the feature parameter of the first operating point includes a set of time parameters (representing a last moment when the first operating point is detected) T2 and a set of positional parameters S1 (a position of the first operating point in the display unit) of the first operating point.

3) A feature parameter P3 (S2, T3) of a second operating point, where the second operating point is an operating point on the progress bar when the finger-touch operation completes the release phase, and the feature parameter of the second operating point includes a set of time parameters (representing a last moment when the second operating point is detected) T3 and a set of positional parameters S2 (a position of the second operating point in the display unit) of the second operating point.

4) Release displacement S2−S1, where the release displacement is corresponding displacement on the progress bar when the finger-touch operation is deemed to be in the release phase. That is, during a period in which a finger of the user releases contact with the display unit (in this case, it is detected that an area of the operating point starts to decrease) until the finger completely does not contact the display unit (in this case, the operating point is not detected), displacement implemented in the display unit by the finger of the user usually is caused by jitter of the finger when the operation is released.

5) Release duration T3−T2, where the release duration is a duration for which the finger-touch operation is deemed to be in the release phase.

As shown in FIG. 12, when the user implements a drag operation at the operating point P1 on the graphical interface to locate content of different progress parts of content loaded on the graphical interface (for example, a multimedia file, a web page, or a document), the electronic device identifies, when the user stops the drag operation at the operating point P2, the set of time parameters T1 and the set of positional parameters S1 (using P1 as displacement fiducial, the set of positional parameters S1 of P2 represents displacement of the operating point P2 with respect to the operating point P1) that correspond to the operating point P2.

When it is sensed that an area of an operating point corresponding to the operating point P2 starts to decrease at the moment T2, it represents that a contact area of a touch point of the finger of the user and the display unit starts to decrease, and the user starts to release the operation at the operating point P2. Therefore, a difference T2−T1 between T2 and T1 is the preview duration.

If jitter occurs during a process that the user releases the operation, a position at which the finger of the user touches the display unit changes. As a result, a set of positional parameters S2 of the operating point P3 (the second operating point) that is finally identified is different from the set of positional parameters S1 (a position in the display unit) of the operating point P2 (the first operating point). A difference T3−T2 between the set of time parameters T2 of the operating point P2 and the set of time parameters T3 of the operating point P3 is the duration in which the operation is in the release phase. Displacement S2−S1 of the operating point P3 with respect to the operating point P2 is displacement generated when the operation is in the release phase (that is, the release displacement).

Operation S302: Select a first operating point as a target operating point when preview duration is not shorter than a preview duration threshold.

When the preview duration is not shorter than the preview duration threshold, it indicates that the user pays attention to the preview for a relatively long time, and usually the user expects to continue to pay attention to previewed content in the later. If a subsequent release operation of the user has an error, the operating point P2 (the first operating point) that is detected when the operation of the user starts to be released is selected as the target operating point.

Operation S303: Update the progress bar and content associated with the progress bar to a predefined position that corresponds to the target operating point.

The target operating point serves as an operating point at which the operation of the user is released, and therefore progress indicated by the operation of the user may be determined based on displacement of the target operating point P2 with respect to the corresponding operating point P1 when locating is started. As shown in FIG. 13, when preview duration for the user to preview content of a 57% progress part is shorter than the preview duration threshold, if an operation error occurs when the user releases the operation, the electronic device detects that the last operating point (the second operating point) triggers to display content of a 60% progress part. If the preview duration is not shorter than the preview duration threshold, it indicates that the user expects to continue to view the content of the 57% progress part, and the content of the 57% progress part in a content source of the graphical interface serves as the target content and is displaced on the graphical interface.

This embodiment discloses an operation processing method. The technical solution disclosed in this embodiment may be applied to any electronic device having a display unit, such as a smartphone or a tablet computer. Usually, a graphical interface based application can run in the electronic device. An operation of a user is received by using the display unit, and an operation result is responded based on the user operation. The operation disclosed in the following embodiments may be an operation implemented by any graphical interface of the electronic device, including a launcher interface of the electronic device, a system setting interface of the electronic device, a multimedia playback interface of the electronic device, an operation interface of a preinstalled application (for example, a system setting tool) of the electronic device, and an operation interface of any third-party application (for example, a social networking application) installed in the electronic device.

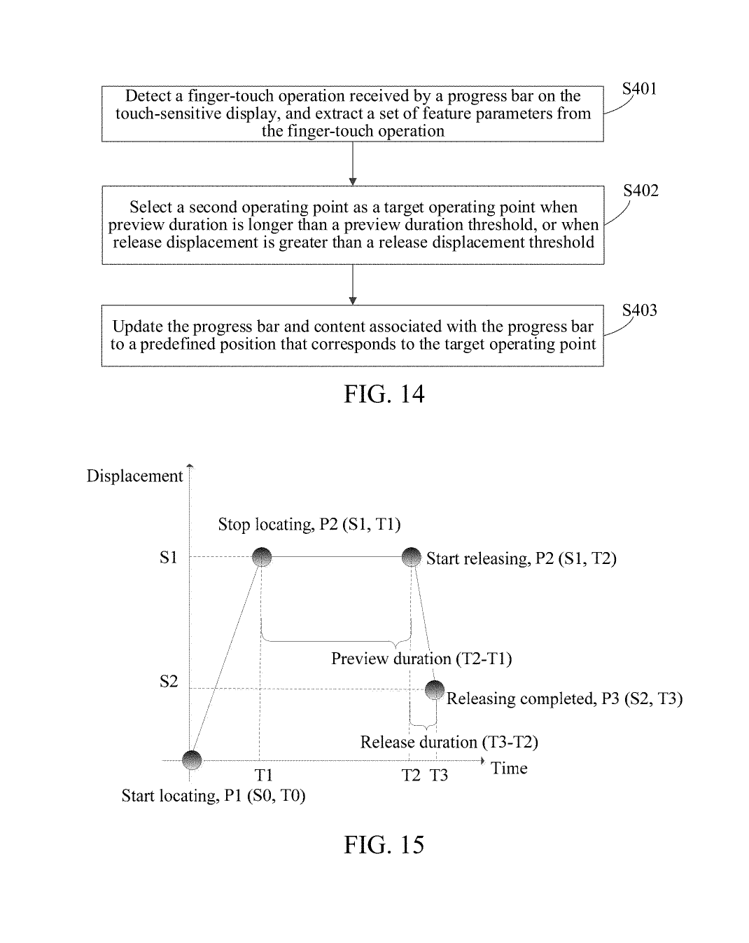

As shown in FIG. 14, the operation processing method disclosed in this embodiment includes the following steps:

Operation S401: Detect a finger-touch operation received by a progress bar, and extract a set of feature parameters from the finger-touch operation.

When the operation is received on graphical interface, a series of operating points that constitute an operation (an operating point is a minimum identification unit for identifying the operation implemented by the user in the display unit of the electronic device) are detected, so as to detect a set of time parameters and a set of positional parameters of a sensed operating point, that is, a moment when the operating point is sensed and a corresponding position (representing a position of the operating point in the display unit).

Based on the set of time parameters and the set of positional parameters of the operating point, at least one of the following set of feature parameters shown in FIG. 15 is determined.

1) Preview duration T2−T1, where the preview duration is a duration for which the finger-touch operation is deemed to be in a preview phase.

2) A feature parameter P2 (S1, T2) of a first operating point, where the first operating point is an operating point on the graphical interface when the operation enters a release phase, and the feature parameter of the first operating point includes a set of time parameters (representing a last moment when the first operating point is detected) T2 and a set of positional parameters S1 (a position of the first operating point in the display unit) of the first operating point.

3) A feature parameter P3 (S2, T3) of a second operating point, where the second operating point is an operating point on the progress bar when the finger-touch operation completes the release phase, and the feature parameter of the second operating point includes a set of time parameters (representing a last moment when the second operating point is detected) T3 and a set of positional parameters S2 (a position of the second operating point in the display unit) of the second operating point.

4) Release displacement S2−S1, where the release displacement is corresponding displacement on the progress bar when the finger-touch operation is deemed to be in the release phase. That is, during a period in which a finger of the user releases contact with the display unit (in this case, it is detected that an area of the operating point starts to decrease) until the finger completely does not contact the display unit (in this case, the operating point is not detected), displacement implemented in the display unit by the finger of the user usually is caused by jitter of the finger when the operation is released.

5) Release duration T3−T2, where the release duration is a duration for which the finger-touch operation is deemed to be in the release phase.

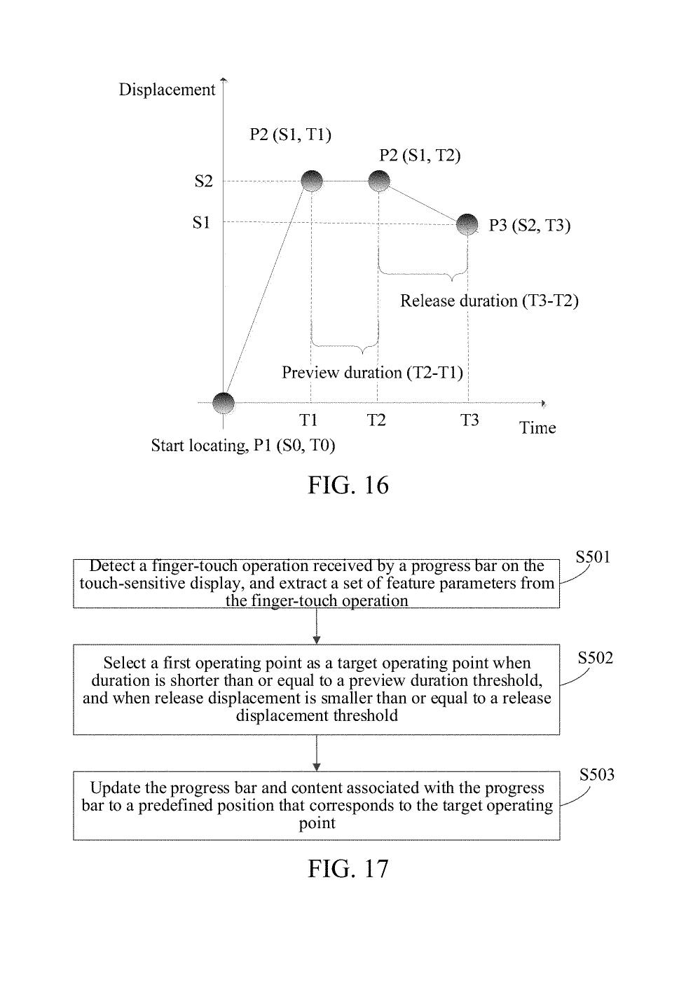

As shown in FIG. 15 and FIG. 16, when the user implements a drag operation at the operating point P1 on the graphical interface to locate content of different progress parts of content loaded on the graphical interface (for example, a multimedia file, a web page, or a document), the electronic device identifies, when the user stops the drag operation at the operating point P2, the set of time parameters T1 and the set of positional parameters S1 (using P1 as displacement fiducial, the set of positional parameters of P2 represents displacement of the operating point P2 with respect to the operating point P1) that correspond to the operating point P2.

When it is sensed that an area of an operating point corresponding to the operating point P2 starts to decrease at the moment T2, it represents that a contact area of a touch point of the finger of the user and the display unit starts to decrease, and the user starts to release the operation at the operating point P2. Therefore, a difference T2−T1 between T2 and T1 is the preview duration.

If jitter occurs during a process that the user releases the operation, a position at which the finger of the user touches the display unit changes. As a result, a set of positional parameters S2 of the operating point P3 (the second operating point) that is finally identified is different from the set of positional parameters S1 (a position in the display unit) of the operating point P2 (the first operating point). A difference T3−T2 between the set of time parameters T2 of the operating point P2 and the set of time parameters T3 of the operating point P3 is the duration in which the operation is in the release phase. Displacement S2−S1 of the operating point P3 with respect to the operating point P2 is displacement generated when the operation is in the release phase (that is, the release displacement).

Operation S402: Select a second operating point as a target operating point when preview duration is longer than a preview duration threshold, or when release displacement is greater than a release displacement threshold.

When the preview duration shown in FIG. 15 is longer than the preview duration threshold, and the release displacement shown in FIG. 16 is greater than the release displacement threshold, it indicates that the user only browses the content randomly, and does not need to pay attention to the content. If a subsequent release operation of the user has an error, the operating point P3 (the second operating point) that is detected when releasing of the operation of the user is completed is selected as the target operating point.

Operation S403: Update the progress bar and content associated with the progress bar to a predefined position that corresponds to the target operating point.

The target operating point serves as an operating point when the operation of the user is released, so that progress indicated by the operation of the user may be determined based on displacement of the target operating point with respect to the corresponding operating point P1 when locating is started. Content of a corresponding progress part in a content source of the graphical interface serves as the target content and is displaced on the graphical interface.

This embodiment discloses an operation processing method. The technical solution disclosed in this embodiment may be applied to any electronic device having a display unit, such as a smartphone or a tablet computer. Usually, a graphical interface based application can run in the electronic device. An operation of a user is received by using the display unit, and an operation result is responded based on the user operation. The operation disclosed in the following embodiments may be an operation implemented by any graphical interface of the electronic device, including a launcher interface of the electronic device, a system setting interface of the electronic device, a multimedia playback interface of the electronic device, an operation interface of a preinstalled application (for example, a system setting tool) of the electronic device, and an operation interface of any third-party application (for example, a social networking application) installed in the electronic device.

As shown in FIG. 17, the operation processing method disclosed in this embodiment includes the following steps:

Operation S501: Detect a finger-touch operation received by a progress bar, and extract a set of feature parameters from the finger-touch operation.

When the operation is received on graphical interface, a series of operating points that constitute an operation (an operating point is a minimum identification unit for identifying the operation implemented by the user in the display unit of the electronic device) are detected, so as to detect a set of time parameters and a set of positional parameters of a sensed operating point, that is, a moment when the operating point is sensed and a corresponding position (representing a position of the operating point in the display unit).

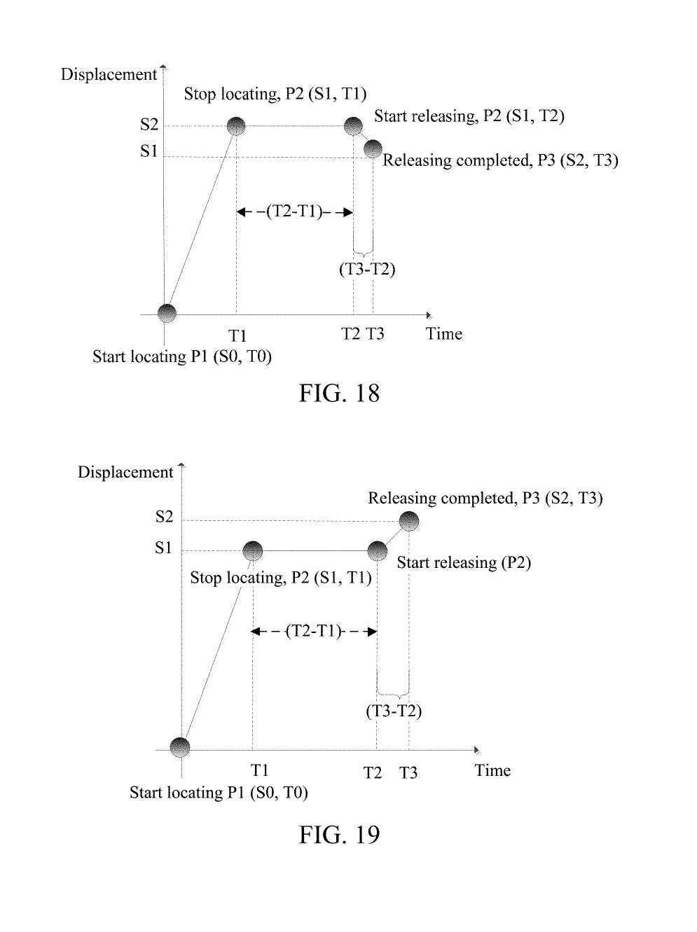

Based on the set of time parameters and the set of positional parameters of the operating point, at least one of the following set of feature parameters shown in FIG. 18 and FIG. 19 is determined.

1) Preview duration T2−T1, where the preview duration is a duration for which the finger-touch operation is deemed to be in a preview phase.

2) A feature parameter P2 (S1, T2) of a first operating point, where the first operating point is an operating point on the graphical interface when the operation enters a release phase, and the feature parameter of the first operating point includes a set of time parameters (representing a last moment when the first operating point is detected) T2 and a set of positional parameters S1 (a position of the first operating point in the display unit) of the first operating point.

3) A feature parameter P3 (S2, T3) of a second operating point, where the second operating point is an operating point on the progress bar when the finger-touch operation completes the release phase, and the feature parameter of the second operating point includes a set of time parameters (representing a last moment when the second operating point is detected) T3 and a set of positional parameters S2 (a position of the second operating point in the display unit) of the second operating point.

4) Release displacement S2−S1, where the release displacement is corresponding displacement on the progress bar when the finger-touch operation is deemed to be in the release phase. That is, during a period in which a finger of the user releases contact with the display unit (in this case, it is detected that an area of the operating point starts to decrease) until the finger completely does not contact the display unit (in this case, the operating point is not detected), displacement implemented in the display unit by the finger of the user usually is caused by jitter of the finger when the operation is released.

5) Release duration T3−T2, where the release duration is a duration for which the finger-touch operation is deemed to be in the release phase.

As shown in FIG. 18 and FIG. 19, when the user implements a drag operation at the operating point P1 on the graphical interface to locate content of different progress parts of content loaded on the graphical interface (for example, a multimedia file, a web page, or a document), the electronic device identifies, when the user stops the drag operation at the operating point P2, the set of time parameters T1 and the set of positional parameters S1 (using P1 as displacement fiducial, the set of positional parameters of P2 represents displacement of the operating point P2 with respect to the operating point P1) that correspond to the operating point P2.

When it is sensed that an area of an operating point corresponding to the operating point P2 starts to decrease at the moment T2, it represents that a contact area of a touch point of the finger of the user and the display unit starts to decrease, and the user starts to release the operation at the operating point P2. Therefore, a difference T2−T1 between T2 and T1 is the preview duration.

If jitter occurs during a process that the user releases the operation, a position at which the finger of the user touches the display unit changes. As a result, a set of positional parameters S2 of the operating point P3 (the second operating point) that is finally identified is different from the set of positional parameters S1 (a position in the display unit) of the operating point P2 (the first operating point). A difference T3−T2 between the set of time parameters T2 of the operating point P2 and the set of time parameters T3 of the operating point P3 is the duration in which the operation is in the release phase. Displacement S2−S1 of the operating point P3 with respect to the operating point P2 is displacement generated when the operation is in the release phase (that is, the release displacement).

Operation S502: Select a first operating point as a target operating point when duration is shorter than or equal to a preview duration threshold, and release displacement is smaller than or equal to a release displacement threshold.

When the preview duration shown in FIG. 18 and FIG. 19 is shorter than the preview duration threshold, and the release displacement is smaller than the release displacement threshold, it indicates that the user is previewing the content and expects to read the currently previewed content. However, when an error occurs when the operation is released, the operating point P2 (the first operating point) that is detected when the operation of the user starts to be released is selected as the target operating point.

Operation S503: Update the progress bar and content associated with the progress bar to a predefined position that corresponds to the target operating point.

The target operating point serves as an operating point when the operation of the user is released, so that progress indicated by the operation of the user may be determined based on displacement of the target operating point P2 with respect to the corresponding operating point P1 when locating is started. Content of a corresponding progress part in a content source of the graphical interface serves as the target content and is displaced on the graphical interface.

This embodiment discloses a computer storage medium, for example, may be a hard disk, a flash memory, or an optical disc. The computer storage medium stores an executable instruction that is used for enabling at least one processor to execute the following operations: detecting a finger-touch operation received by a progress bar, extracting a set of feature parameters from the finger-touch operation; parsing the set of feature parameters to identify candidate operating points, and selecting a target operating point from the candidate operating points when the finger-touch operation is deemed to be in a release phase; and displaying target content that is in content loaded on the graphical interface and that corresponds to the target operating point.

Optionally, the executable instruction is further used for enabling at least one processor to execute the following operations: detecting a set of time parameters and a set of positional parameters of a sensed operating point when the finger-touch operation is received on the progress bar; and

determining, based on the set of time parameters and the set of positional parameters of the operating point, at least one of the following set of feature parameters:

a preview duration, where the preview duration is a duration for which the finger-touch operation is deemed to be in a preview phase;

a first operating point, where the first operating point is an operating point on the progress bar when the finger-touch operation enters the release phase;

a second operating point, where the second operating point is an operating point on the progress bar when the finger-touch operation completes the release phase;

a release displacement, where the release displacement is corresponding displacement on the progress bar when the finger-touch operation is deemed to be in the release phase; and

a release duration, where the release duration is a duration for which the finger-touch operation is deemed to be in the release phase.

Optionally, the executable instruction is further used for enabling at least one processor to execute the following operation: selecting the second operating point as the target operating point when the preview duration is shorter than a preview duration threshold.

Optionally, the executable instruction is further used for enabling at least one processor to execute the following operation: selecting the first operating point as the target operating point when the preview duration is longer than or equal to the preview duration threshold.

Optionally, the executable instruction is further used for enabling at least one processor to execute the following operation: selecting the second operating point as the target operating point when the preview duration is longer than the preview duration threshold, or when the release displacement is greater than a release displacement threshold.

Optionally, the executable instruction is further used for enabling at least one processor to execute the following operation: selecting the first operating point as the target operating point when the duration is shorter than or equal to the preview duration threshold, and the release displacement is smaller than or equal to the release displacement threshold.

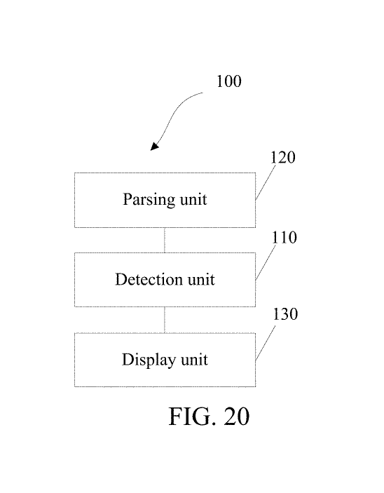

This embodiment discloses an electronic device 100 that is configured to implement the operation processing method disclosed in the foregoing embodiments, avoiding a problem that an operation result is incorrect because there is an error in a user operation. The electronic device is provided with a display unit that supports a touch operation. In some embodiments, the electronic device is a mobile phone having one or more processors for executing modules, programs and/or instructions stored in memory and thereby performing processing operations; one or more network or other communications interfaces; and one or more communication buses for interconnecting these components. The communication buses optionally include circuitry (sometimes called a chipset) that interconnects and controls communications between system components. The electronic device optionally includes a user interface comprising a display device and one or more input device(s) (e.g., keyboard, mouse, touch-sensitive display). In some embodiments, an input device is integrated with the display device. For example, a touchscreen includes a touch-sensitive display integrated with the display device. Memory includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory may optionally include one or more storage devices remotely located from the CPU(s). Memory, or alternately the non-volatile memory device(s) within memory, comprises a non-transitory computer readable storage medium. In some embodiments, memory, or the computer readable storage medium of memory stores the following programs, modules and data structures, or a subset thereof as shown in FIG. 20: a detection unit 110, configured to detect a finger-touch operation received by a progress bar, extracting a set of feature parameters from the finger-touch operation; a parsing unit 120, configured to parse the feature parameter, and select a target operating point from the candidate operating points when the finger-touch operation is deemed to be in a release phase; and a display unit 130, configured to display target content that is in content loaded on the graphical interface and that corresponds to the target operating point.

As an example, the detection unit 110 includes: a detection module, configured to detect a set of time parameters and a set of positional parameters of a sensed operating point when the finger-touch operation is received on the progress bar; and a determining module, configured to determine, based on the set of time parameters and the set of positional parameters of the operating point, at least one of the following set of feature parameters: a preview duration, where the preview duration is a duration for which the finger-touch operation is deemed to be in a preview phase; a first operating point, where the first operating point is an operating point on the progress bar when the finger-touch operation enters the release phase; a second operating point, where the second operating point is an operating point on the progress bar when the finger-touch operation completes the release phase; a release displacement, where the release displacement is corresponding displacement on the progress bar when the finger-touch operation is deemed to be in the release phase; and a release duration, where the release duration is a duration for which the finger-touch operation is deemed to be in the release phase.

As an example, the parsing unit 120 is further configured to select the second operating point as the target operating point when the preview duration is shorter than a preview duration threshold.

As an example, the parsing unit 120 is further configured to select the first operating point as the target operating point when the preview duration is longer than or equal to the preview duration threshold.

As an example, the parsing unit 120 is further configured to select the second operating point as the target operating point when the preview duration is longer than the preview duration threshold, or when the release displacement is greater than a release displacement threshold.

As an example, the parsing unit 120 is further configured to select the first operating point as the target operating point when the duration is shorter than or equal to the preview duration threshold, and the release displacement is smaller than or equal to the release displacement threshold.

In actual applications, the detection unit 110, the parsing unit 120, and the display unit 130 may be implemented by a microprocessor (MCU) such as an application processor (AP), an application-specific integrated circuit (ASIC), or a field programmable gate array (FPGA) in the electronic device 100.

In view of the above, in the embodiments of the present disclosure, by parsing a feature parameter of an operation, an operation feature of the operation may be obtained from a parsing result, so as to select, based on different features of the operation, a target operating point from the candidate operating points when the finger-touch operation is deemed to be in a release phase. When an error exists in the operation, the error exists in the operation is corrected by using an operating point corresponding to the operation feature as the target operating point. Subsequently, the operation may be responded by using a corrected target operating point, so as to ensure that an operation result is consistent with an operation result expected by the user, and prevent the user from operating again to adjust the operation result. Therefore, the operating efficiency is high, and user experience is improved.

A person of ordinary skill in the art may understand that all or some of the steps of the foregoing method embodiments may be implemented by program instructing relevant hardware. The foregoing program may be stored in a non-transitory computer readable storage medium. When the program runs, the steps of the foregoing method embodiments are performed. The foregoing storage medium includes any medium that can store program code, such as: a mobile storage device, a random access memory (RAM), a read-only memory (ROM), a magnetic disc, or an optical disc.

Alternatively, when the foregoing integrated unit of the present disclosure is implemented in the form of a software functional module and sold or used as an independent product, the integrated unit may also be stored in a computer-readable storage medium. Based on such an understanding, the technical solutions of the embodiments of the present disclosure essentially, or the part contributing to the related technology may be implemented in a form of a software product. The computer software product is stored in a storage medium, and includes several instructions for instructing a computer device (which may be a personal computer, a server, or a network device) to perform all or some of the methods described in the embodiments of the present disclosure. Moreover, the foregoing storage medium includes all media that can store program code such as: a mobile storage device, an RAM, an ROM, a magnetic disc, or an optical disc.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

What is claimed is:

1. A method for performing an operation in accordance with a user interaction with a touch-sensitive display of an electronic device having one or more processors and memory storing programs to be executed by the one or more processors, the method comprising:
detecting a finger-touch operation received by a progress bar on the touch-sensitive display;
extracting a set of feature parameters from the finger-touch operation;
parsing the set of feature parameters to identify candidate operating points;
selecting a target operating point from the candidate operating points when the finger-touch operation is deemed to be in a release phase; and
updating the progress bar and content associated with the progress bar to a predefined position that corresponds to the target operating point.

2. The method according to claim 1, wherein the operation of extracting a set of feature parameters from the finger-touch operation comprising:
detecting a set of time parameters and a set of positional parameters of a sensed operating point when the finger-touch operation is received on the progress bar; and
determining, based on the set of time parameters and the set of positional parameters of the operating point, at least one of the following set of feature parameters:
a preview duration, wherein the preview duration is a duration for which the finger-touch operation is deemed to be in a preview phase;
a first operating point, wherein the first operating point is an operating point on the progress bar when the finger-touch operation enters the release phase;
a second operating point, wherein the second operating point is an operating point on the progress bar when the finger-touch operation completes the release phase;
a release displacement, wherein the release displacement is corresponding displacement on the progress bar when the finger-touch operation is deemed to be in the release phase; and
a release duration, wherein the release duration is a duration for which the finger-touch operation is deemed to be in the release phase.

3. The method according to claim 2, wherein the operation of selecting a target operating point from the candidate operating points when the finger-touch operation is deemed to be in a release phase comprising:
selecting the second operating point as the target operating point when the preview duration is shorter than a preview duration threshold.

4. The method according to claim 2, wherein the operation of selecting a target operating point from the candidate operating points when the finger-touch operation is deemed to be in a release phase comprising:
selecting the first operating point as the target operating point when the preview duration is longer than or equal to a preview duration threshold.

5. The method according to claim 2, wherein the operation of selecting a target operating point from the candidate operating points when the finger-touch operation is deemed to be in a release phase comprising:
selecting the second operating point as the target operating point when the preview duration is longer than a preview duration threshold, or when the release displacement is greater than a release displacement threshold.

6. The method according to claim 2, wherein the operation of selecting a target operating point from the candidate operating points when the finger-touch operation is deemed to be in a release phase comprising:
selecting the first operating point as the target operating point when the duration is shorter than or equal to the preview duration threshold, and the release displacement is smaller than or equal to the release displacement threshold.

7. An electronic device, comprising:
one or more processors;
a touch-sensitive display;
memory; and
a plurality of programs stored in the memory, wherein the plurality of programs, when executed by the one or more processors, cause the electronic device to perform the following operations:
detecting a finger-touch operation received by a progress bar on the touch-sensitive display;
extracting a set of feature parameters from the finger-touch operation;
parsing the set of feature parameters to identify candidate operating points;
selecting a target operating point from the candidate operating points when the finger-touch operation is deemed to be in a release phase; and
updating the progress bar and content associated with the progress bar to a predefined position that corresponds to the target operating point.

8. The electronic device according to claim 7, wherein the operation of extracting a set of feature parameters from the finger-touch operation comprising:
detecting a set of time parameters and a set of positional parameters of a sensed operating point when the finger-touch operation is received on the progress bar; and
determining, based on the set of time parameters and the set of positional parameters of the operating point, at least one of the following set of feature parameters:
a preview duration, wherein the preview duration is a duration for which the finger-touch operation is deemed to be in a preview phase;
a first operating point, wherein the first operating point is an operating point on the progress bar when the finger-touch operation enters the release phase;
a second operating point, wherein the second operating point is an operating point on the progress bar when the finger-touch operation completes the release phase;
a release displacement, wherein the release displacement is corresponding displacement on the progress bar when the finger-touch operation is deemed to be in the release phase; and
a release duration, wherein the release duration is a duration for which the finger-touch operation is deemed to be in the release phase.

9. The electronic device according to claim 8, wherein the operation of selecting a target operating point from the candidate operating points when the finger-touch operation is deemed to be in a release phase comprising:
selecting the second operating point as the target operating point when the preview duration is shorter than a preview duration threshold.

10. The electronic device according to claim 8, wherein the operation of selecting a target operating point from the candidate operating points when the finger-touch operation is deemed to be in a release phase comprising:
selecting the first operating point as the target operating point when the preview duration is longer than or equal to a preview duration threshold.

11. The electronic device according to claim 8, wherein the operation of selecting a target operating point from the candidate operating points when the finger-touch operation is deemed to be in a release phase comprising:
selecting the second operating point as the target operating point when the preview duration is longer than a preview duration threshold, or when the release displacement is greater than a release displacement threshold.

12. The electronic device according to claim 8, wherein the operation of selecting a target operating point from the candidate operating points when the finger-touch operation is deemed to be in a release phase comprising:
selecting the first operating point as the target operating point when the duration is shorter than or equal to the preview duration threshold, and the release displacement is smaller than or equal to the release displacement threshold.

13. A non-transitory computer readable storage medium associated with an electronic device having one or more processors and a touch-sensitive display, the computer readable storage medium storing a plurality of programs that, when executed by the one or more processors, cause the electronic device to perform the following operations:
detecting a finger-touch operation received by a progress bar on the touch-sensitive display;
extracting a set of feature parameters from the finger-touch operation;
parsing the set of feature parameters to identify candidate operating points;
selecting a target operating point from the candidate operating points when the finger-touch operation is deemed to be in a release phase; and
updating the progress bar and content associated with the progress bar to a predefined position that corresponds to the target operating point.

14. The non-transitory computer readable storage medium according to claim 13, wherein the operation of extracting a set of feature parameters from the finger-touch operation comprising:
detecting a set of time parameters and a set of positional parameters of a sensed operating point when the finger-touch operation is received on the progress bar; and
determining, based on the set of time parameters and the set of positional parameters of the operating point, at least one of the following set of feature parameters:
a preview duration, wherein the preview duration is a duration for which the finger-touch operation is deemed to be in a preview phase;
a first operating point, wherein the first operating point is an operating point on the progress bar when the finger-touch operation enters the release phase;
a second operating point, wherein the second operating point is an operating point on the progress bar when the finger-touch operation completes the release phase;
a release displacement, wherein the release displacement is corresponding displacement on the progress bar when the finger-touch operation is deemed to be in the release phase; and
a release duration, wherein the release duration is a duration for which the finger-touch operation is deemed to be in the release phase.

15. The non-transitory computer readable storage medium according to claim 14, wherein the operation of selecting a target operating point from the candidate operating points when the finger-touch operation is deemed to be in a release phase comprising:
selecting the second operating point as the target operating point when the preview duration is shorter than a preview duration threshold.

16. The non-transitory computer readable storage medium according to claim 14, wherein the operation of selecting a target operating point from the candidate operating points when the finger-touch operation is deemed to be in a release phase comprising:
selecting the first operating point as the target operating point when the preview duration is longer than or equal to a preview duration threshold.

17. The non-transitory computer readable storage medium according to claim 14, wherein the operation of selecting a target operating point from the candidate operating points when the finger-touch operation is deemed to be in a release phase comprising:
selecting the second operating point as the target operating point when the preview duration is longer than a preview duration threshold, or when the release displacement is greater than a release displacement threshold.

18. The non-transitory computer readable storage medium according to claim 14, wherein the operation of selecting a target operating point from the candidate operating points when the finger-touch operation is deemed to be in a release phase comprising:
selecting the first operating point as the target operating point when the duration is shorter than or equal to the preview duration threshold, and the release displacement is smaller than or equal to the release displacement threshold.
